(19) United States
(12) Patent Application Publication
(10) Pub. No.: US 2020/0224750 A1
(43) Pub. Date: Jul. 16, 2020

(54) Differential Deceleration and Continuously Variable Transmission Gear Box with Self-locking Functional Small Tooth Number Difference Planetary Gear

(71) Applicant: Peiji Li, Tongxiang City (CN)

(72) Inventor: Peiji Li, Tongxiang City (CN)

(21) Appl. No.: 16/357,261

(22) Filed: Mar. 18, 2019

(30) Foreign Application Priority Data
Jan. 11, 2019 (CN) 201910026398.9

(51) Int. Cl. F16H 3/74; F16H 48/28; F16H 48/10

(52) U.S. Cl. CPC F16H 3/74; F16H 48/10; F16H 48/28

(57) ABSTRACT

The invention discloures a differential deceleration and continuously variable transmission gear box with self-locking functional small tooth number difference planetary gear, comprising a planetary gear mechanism comprising a planetary carrier arranged floatingly, the small tooth number difference planetary gear mechanism comprises small tooth number difference planetary gear and an output disk with self-locking function arranged on the small tooth number difference planetary gear.

### FIELD OF THE INVENTION

The invention relates to the field of mechanical transmission deceleration self-locking and variable transmission, in particular to a differential deceleration and continuously variable transmission gear box with self-locking functional small tooth number difference planetary gear.

### BACKGROUND

There is a self-locking worm gear pair deceleration mechanism in the traditional mechanical transmission deceleration, and two prior patents have been disclosed, including the patent number 201110046458.7, the name is: Planet differential motion infinitely variable speed gear box, and the patent number: 2017213108247.4, the name is: Self-locking worm gear pair of the planet differential gear train of force balance self-locking of the speed adjusting gear box, planetary differential balance self-locking mechanism is designed in both inventions; the self-locking worm gear pair realizes the self-locking function by relying on the helix angle of worm being smaller than the friction angle of the material and relying on the friction resisting moment between worm gears, therefore, mechanical efficiency thereof is low at around 45%, which limits the scope of use, and the planetary differential balance self-locking mechanism designed in the disclosed invention can achieve a mechanical efficiency of more than 80%, but the prior art has to be composed of a planetary mechanism and two sets of small tooth number difference planetary mechanism, and achieves the self-locking function by relying on the force balance between three sets of planetary differential gear mechanism, and even added a self-locking worm wheel pair to increase security, thereby, the complicated structure increase the manufacturing cost and security risks.

### SUMMARY OF THE INVENTION

In order to solve the above problem, the invention provides a technical scheme: A differential deceleration and continuously variable transmission gear box with self-locking functional small tooth number difference planetary gear, comprising, a planetary gear mechanism comprising a planetary carrier arranged floatingly, a small tooth number difference planetary gear mechanism with self-locking function, the small tooth number difference planetary gear mechanism comprises a small tooth number difference planetary gear and an output disk with self-locking function which arranged on the small tooth number difference planetary gear;

the planetary gear mechanism comprises a planetary carrier arranged floatingly, a gear ring of the planetary gear mechanism, a bracket used for setting the gear ring of the planetary gear mechanism, planetary gear, and sun gear, the planetary gear mechanism outputs rotating speed and torque through a connecting output roller of the gear ring of the planetary gear mechanism, the sun gear of the planetary gear mechanism inputs power by connecting to a power machine via a central roller, a hinge pin of the planetary gear is inserted into the corresponding hole on the sun gear;

the planetary carrier is floatingly arranged, and fixedly connected with the output disk with self-locking function which arranged on the small tooth number difference planetary gear;

an eccentric sleeve of the small tooth number difference planetary gear mechanism is connected with a small power motor for speed regulation via sleeve, the small power motor for speed regulation drives the eccentric sleeve of the small tooth number difference planetary gear mechanism to rotate by continuously input rotating speed, thereby the small tooth number difference planetary gear mechanism is unlocked with the the output disk with self-locking function thereof, and the floating planetary carrier of the planetary gear mechanism connected to the output disk is operated to perform a differential continuously variable transmission output;

As the improvement of the invention, the small tooth number difference planetary gear is provided with six hinge pins, the hinge pins are respectively inserted into eccentric holes of the eccentric sleeve on the output disk, thereby the small tooth number difference planetary gear mechanism is subjected to more than one peripheral force concentric with the eccentric sleeve of the small tooth number difference planetary gear mechanism, to achieve that the small tooth number difference planetary gear mechanism is constrained and self-locking;

the eccentric sleeve is mounted on the output disk by needle roller bearing, and the eccentric hole spacing of the eccentric sleeve is the same as the eccentric spacing of the small tooth number difference planetary gear mechanism, thereby the force that the six eccentric sleeves mounted on the output disk by needle roller bearing receives is two sets of eccentric forces against each other to achieve constrained self-locking. The six hinge pins in the eccentric hole of the eccentric sleeve produce a simple peripheral force centered on the eccentric circle and are transmitted to the small tooth number difference planetary gear, thereby the small tooth number difference planetary gear also have self-locking function.

As the improvement of the invention, the small tooth number difference planetary differential gear mechanism and the output disk are connected with the output roller and arranged in engine base.

As the improvement of the invention, the continuously variable transmission gear box is the main body of the invention, and the small tooth number difference planetary gear mechanism is the main body that realizes constrained self-locking.

After adopting the above structure, the invention has the following advantages: the invention disclosures a double planetary differential continuously variable transmission gear box, which comprises a small tooth number difference planetary gear mechanism with self-locking function and a planetary gear mechanism comprising a floating planetary carrier, the invention has the advantages of compact structure, reliable function, high efficiency, safe and stable operation, and easy to automatic transmission, and the invention relates to electromechanical products of various vehicles, machine tools and machining centers which need to be equipped with large-scale variable transmission, and is also electromechanical products of mining and tunneling which need ultra-low rotating speed and large output torque;

The invention relates to a small tooth number difference planetary gear deceleration box with self-locking function, and is the best match of electromechanical products which need deceleration and self-locking such as: hoist, port crane, gantry crane, various elevators, tram height, amusement machine, Ship anchor chain machine, and construction machinery, etc., which can prevent serious accident of lag opening caused by a brake failure when the conventional crane adopts braking mechanism.

### DESCRIPTION OF THE DRAWINGS

FIG. 1 is a section view showing the assembly of a small tooth number difference planetary gear deceleration machine with self-locking function.

FIG. 2 is the A-A section view of FIG. 1.

FIG. 3 is the B-B section view of FIG. 1.

FIG. 4 is a force diagram showing a conventional small tooth number difference planetary gear mechanism.

FIG. 5 is a section view showing the assembly of a double planetary differential continuously variable transmission gear box composed of a planetary gear mechanism with a floating planetary carrier is coupled with a self-locking small tooth number difference planetary differential gear mechanism.

FIG. 6 is the A-A section view of FIG. 5.

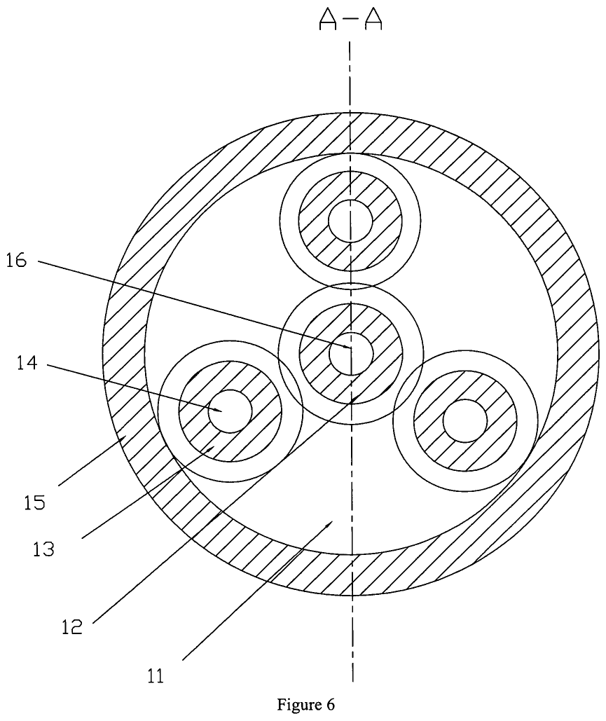

In the accompanying drawings:

1 refers to output roller of small tooth number difference planetary gear deceleration box;

2 refers to output disk of small tooth number difference planetary gear mechanism;

3 refers to six eccentric sleeves mounted on the output disk by needle roller bearing;

4 refers to six hinge pins arranged on small tooth number difference planetary gear;

5 refers to small tooth number difference planetary gear;

6 refers to gear ring of small tooth number difference planetary gear mechanism arranged in engine base;

7 refers to eccentric sleeve of small tooth number difference planetary gear;

8 refers to power input roller of small tooth number difference planetary gear mechanism;

9 refers to output roller of double planetary differential continuously variable transmission gear box;

10 refers to a bracket used for the connecting output roller setting the gear ring of the planetary gear mechanism;

11 refers to a planetary carrier floatingly arranged on the planetary gear mechanism ;

12 refers to sun gear of planetary gear;

13 refers to planetary gear

14 refers to a hinge pin used for mounting the planetary gear;

15 refers to gear ring of the planetary gear;

16 refers to a central roller of the planetary gear mechanism used for connecting power machine;

17 refers to input sleeve of eccentric sleeve on the small tooth number difference planetary gear mechanism;

O′ refers to the center of the small tooth number difference planetary gear mechanism;

O″ refers to the eccentric center small tooth number difference planetary gear mechanism;

P′ refers to the reaction force of external load on the self-locking mechanism;

P″ refers to the meshing reaction force of gear ring of the small tooth number difference planetary gear mechanism on the planetary gear;

α ω refers to meshing angle of the small tooth number difference planetary gear mechanism;

### PREFERRED EMBODIMENTS OF THE INVENTION

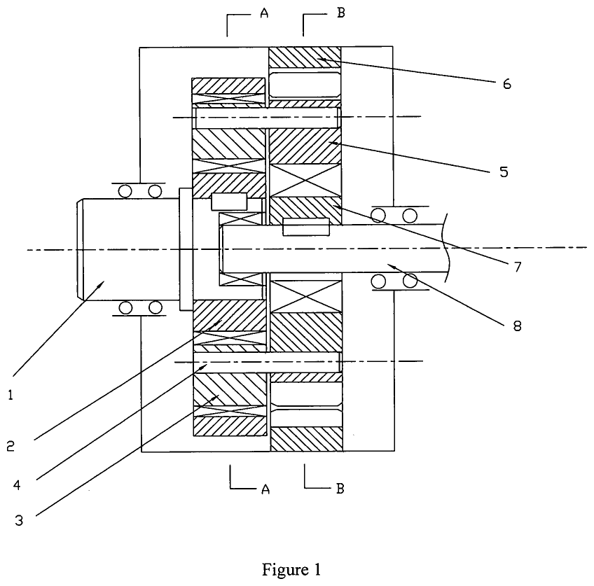

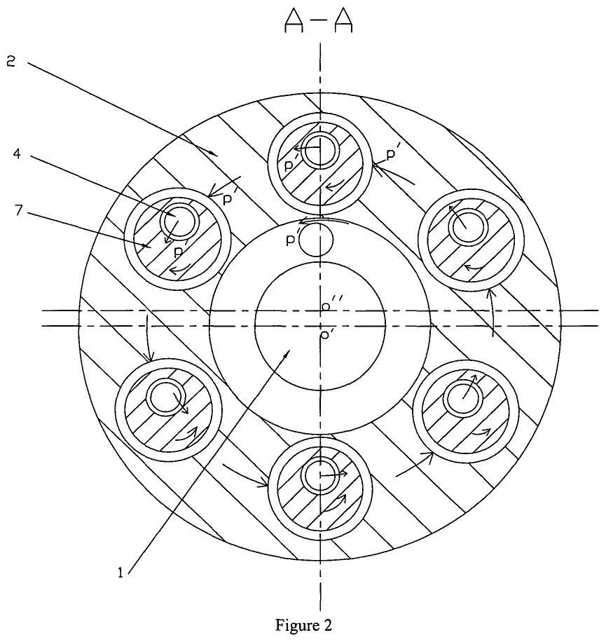

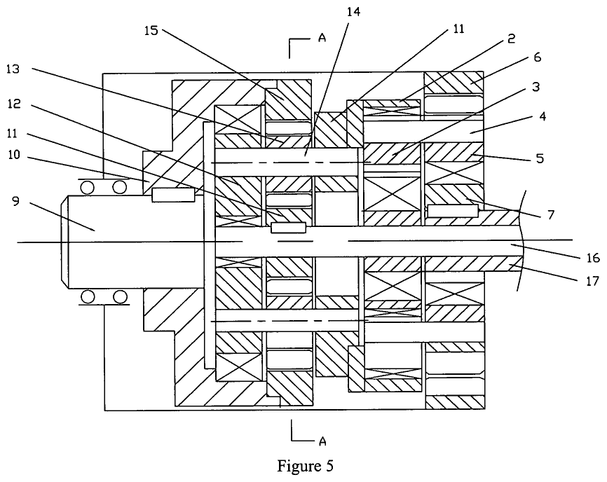

With reference to FIG.1-5, a differential deceleration and continuously variable transmission gear box with self-locking functional small tooth number difference planetary gear, comprising, a planetary gear mechanism comprising a planetary carrier arranged floatingly, a small tooth number difference planetary gear mechanism with self-locking function, the small tooth number difference planetary gear mechanism comprises a small tooth number difference planetary gear 5 and an output disk 2 with self-locking function which arranged on the small tooth number difference planetary gear 5;

the planetary gear mechanism comprises a planetary carrier 11 arranged floatingly, a gear ring 15 of the planetary gear mechanism, a bracket 10 used for setting the gear ring 15 of the planetary gear mechanism, planetary gear 13, and sun gear 12, the planetary gear mechanism outputs rotating speed and torque through a connecting output roller 9 of the gear ring 15 of the planetary gear mechanism, the sun gear 12 of the planetary gear mechanism inputs power by connecting to a power machine via a central roller 16, a hinge pin 14 of the planetary gear 13 is inserted into the corresponding hole on the sun gear 12;

the planetary carrier 11 is floatingly arranged, and fixedly connected with the output disk 2 with self-locking function which arranged on the small tooth number difference planetary gear 5;

an eccentric sleeve 3 of the small tooth number difference planetary gear mechanism is connected with a small power motor for speed regulation via sleeve, the small power motor for speed regulation drives the eccentric sleeve 3 of the small tooth number difference planetary gear mechanism to rotate by continuously input rotating speed, thereby the small tooth number difference planetary gear mechanism 5 is unlocked with the the output disk 2 with self-locking function thereof, and the floating planetary carrier 11 of the planetary gear mechanism connected to the output disk 2 is operated to perform a differential continuously variable transmission output.

As a preferred embodiment of the invention, the small tooth number difference planetary gear 5 is provided with six hinge pins 4, the hinge pins 4 are respectively inserted into eccentric holes of the eccentric sleeve 3 on the output disk 2, thereby the small tooth number difference planetary gear mechanism is subjected to more than one peripheral force concentric with the eccentric sleeve 3 of the small tooth number difference planetary gear mechanism, to achieve that the small tooth number difference planetary gear mechanism is constrained and self-locking;

the eccentric sleeve 3 is mounted on the output disk 2 by needle roller bearing, and the eccentric hole spacing of the eccentric sleeve 3 is the same as the eccentric spacing of the small tooth number difference planetary gear mechanism, thereby the force that the six eccentric sleeves 3 mounted on the output disk 2 by needle roller bearing receives is two sets of eccentric forces against each other to achieve constrained self-locking. The six hinge pins 4 in the eccentric hole of the eccentric sleeve 3 produce a simple peripheral force centered on the eccentric circle and are transmitted to the small tooth number difference planetary gear, thereby the small tooth number difference planetary gear also have self-locking function.

As a preferred embodiment of the invention, the small tooth number difference planetary differential gear mechanism and the output disk 2 are connected with the output roller and arranged in engine base.

As a preferred embodiment of the invention, the continuously variable transmission gear box is the main body of the invention, and the small tooth number difference planetary gear mechanism is the main body that realizes constrained self-locking.

The invention provides a conventional small tooth number difference planetary differential gear 5 and an output disk 2 connected with thereof as the main body of the self-locking mechanism, six eccentric sleeves 3 are mounted on the output disk 2 by needle roller bearing, eccentric holes are provided on the eccentric sleeve 3, and the eccentric spacing of the eccentric sleeve 3 has to be exactly the same as the eccentric spacing of the small tooth number difference planetary gear 5, the six hinge pins 4 fixed on the small tooth number difference planetary gear 5 are inserted into eccentric holes, thereby the small tooth number difference planetary differential gear mechanism with self-locking function is obtained.

The self-locking function of the small tooth number difference planetary differential gear mechanism 5 with self-locking function is realized as the following:

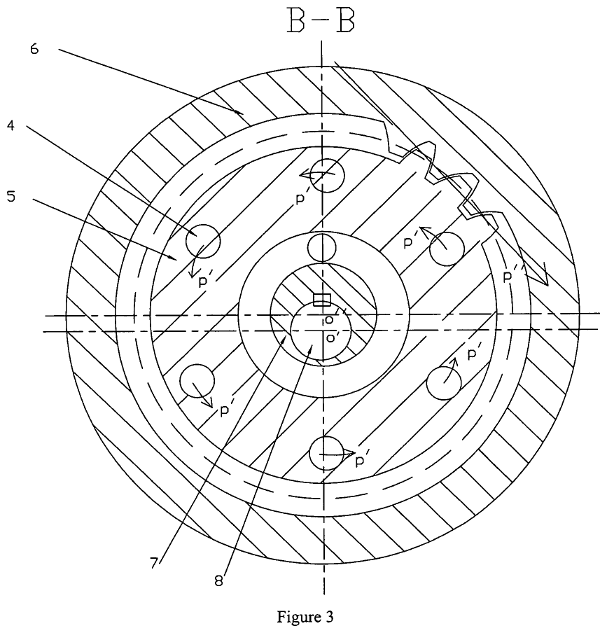

As shown in FIG.3, the arrow indicates that the rotation transmitted from the counter torque of the external load to the output disk 2 is in anti-clockwise direction, the output disk 2 generates a force P′ on the six eccentric sleeves 3 and the six hinge pins 4 on the small tooth number difference planetary gear 5, the force on the six eccentric sleeves 3 is caused by a running torque generated by the six hinge pins 4 being inserted into eccentric holes, and the radius of the torque is the eccentric value of the small tooth number difference planetary gear 5, but the rotation direction generated by the six eccentric sleeves 3 can be divided into positive and negative directions depending on the position thereof, the output disk 2 acts on the eccentric sleeves 3 in a anti-clockwise direction, thereby three eccentric sleeves 3 above the central roller are rotated in clockwise direction, while the three eccentric sleeves 3 below the central roller are rotated in anti-clockwise direction, and the mechanism can not rotate with the forces against each other, the mutual positions of the inserted six hinge pins 4 are fixed, and the six eccentric sleeves 3 are also impossible to rotate, which has no effect on the output disk 2 mounted centrally, the constrained self-locking is the key to the small tooth number difference planetary gear mechanism with self-locking function;

six hinge pins 4 fixed on the small tooth number difference planetary gear 5 are subjected to the peripheral force P′ of the output disk 2 in anti-clockwise direction, for the eccentric sleeves on the output disk can not change the prior position, the six hinge pins are subjected to a simple eccentric peripheral force P′, and transmitting the eccentric peripheral force P′ to the small tooth number difference planetary gear 5 and driving the small tooth number difference planetary gear 5 to rotate around the eccentric sleeve 3 of the small tooth number difference planetary gear 5, while the small tooth number difference planetary gear 5 is meshed with gear ring 6 fixed on the engine base, and is self-locking constrained by the gear ring 6 and can not rotate, and for the small tooth number difference planetary gear 5 is subjected to peripheral force centered on the eccentric sleeve 3 thereof, there is not any forces acting on the eccentric sleeve 3 of the small tooth number difference planetary gear 5, and the mechanism is in a stationary state;

when the output transmission is required, the power machine drives the eccentric sleeve 3 of the small tooth number difference planetary gear 5 to rotate in clockwise direction, and the small tooth number difference planetary gear 5 rotates to output in anti-clockwise direction and drives the six hinge pins 4 to rotate at the same time; the six hinge pins 4 fixed on the small tooth number difference planetary gear 5 have two kinds of movements, one is a revolution motion synchronous with the small tooth number difference planetary gear 5, which drives the output disk 2 to rotate, while the another is a rotational motion synchronous with the eccentric sleeves 3 of the small tooth number difference planetary gear 5, which may change the position of the six hinge pins 4 on the output disk 2 to perform a rotating motion with eccentric value as radius in the eccentric sleeves 3 of the output disk 2, thereby the eccentric sleeves 3 on the output disk 2 are rotated to unlock the small tooth number difference planetary gear 5 to operate, that is the unlocking operation of the locked planetary gear mechanism.

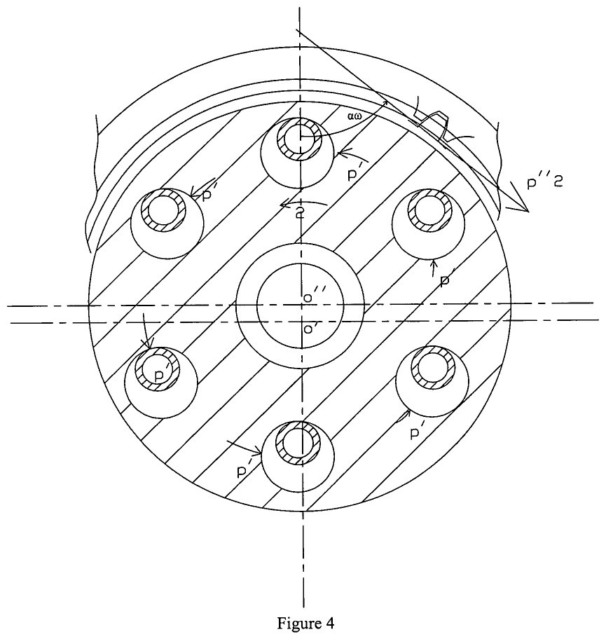

As shown in FIG. 4, the prior conventional small tooth number difference planetary gear mechanism does not have self-locking function, the reason is that a sleeve is provided on the hinge pin of the output disk, there is a point contact between the hinge pin and the output disk, and the output disk is transmitted a force to the small tooth number difference planetary gear which is a vertical force P′ perpendicular to the horizontal plane on the left side to drive the small tooth number difference planetary gear rotate in anti-clockwise direction, and a meshing force P″ is generated on the right side of the small tooth number difference planetary gear for being constrained by the fixed gear ring, the resultant force of P′ and P″ is a tilt force towards clockwise direction, which can be decomposed a horizontal component PO towards the eccentric sleeve of the small tooth number difference planetary gear to drive the small tooth number difference planetary gear rotate in clockwise direction, and the small tooth number difference planetary gear rotates in anti-clockwise direction and can not be constrained and self-locking.

The invention provided a double planetary differential continuously variable transmission gear box, comprising a planetary gear mechanism comprising a planetary carrier arranged floatingly and a small tooth number difference planetary gear mechanism with self-locking function, the planetary carrier 11 of the planetary gear mechanism of the invention is not fixed and in a floating state, and fixed on the output disk 2 of the small tooth number difference planetary gear mechanism, which innovatively change the prior to add six eccentric sleeves 3 on the output disk 2 of the output mechanism of the small tooth number difference planetary gear mechanism to realize the constrained self-locking, when the planetary carrier 11 is locked, the planetary gear mechanism is one-stage planetary gear deceleration transmission, and when the floating planetary carrier 11 is unlocked and to rotate, the output gear ring 6 of the planetary gear mechanism performs a deceleration continuously variable transmission, and the output torque is increased in proportion to the rotating output speed, and the mechanism has the complete constant output characteristic;

The small tooth number difference planetary gear mechanism of the invention only adds six eccentric sleeves 3 on the output disk 2 of the output mechanism by needle roller bearing, and inserting the six hinge pins 4 fixed on the small tooth number difference planetary gear into the eccentric holes of the eccentric sleeve 3 on the output disk 2, which realizes the self-locking function of the small tooth number difference planetary differential mechanism. And a full set of double planetary differential continuously variable transmission gear box is obtained by only two planetary differential gear mechanisms.

The invention has the advantageous effects that simplifying the structure, decreasing the weight of the mechanism, reducing manufacturing cost, improving the mechanical efficiency, increasing operation safety, reducing operating noise and avoiding security problems, and all make the operation of the invention more practical, and enable various vehicle machine tools and base working machines matched with the invention have higher working performance and energy saving effect, the invention is the ultimate application of the gear variable transmission technology, and the invention provides a best energy-saving technology and a best match to improve the performance of various mechanical and electrical products for various fields of electromechanical, especially for the field of various vehicle metal cutting machine tools and other machines.

The invention and the embodiments thereof have been described above, and the description is not limited thereto, only one embodiment of the invention is shown in the accompanying drawings, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

1. A differential deceleration and continuously variable transmission gear box with self-locking functional small tooth number difference planetary gear, comprising, a planetary gear mechanism comprising a planetary carrier arranged floatingly, a small tooth number difference planetary gear mechanism with self-locking function, the small tooth number difference planetary gear mechanism comprises a small tooth number difference planetary gear and an output disk with self-locking function which arranged on the small tooth number difference planetary gear;
the planetary gear mechanism comprises a planetary carrier arranged floatingly, a gear ring of the planetary gear mechanism, a bracket used for setting the gear ring of the planetary gear mechanism, planetary gear, and sun gear, the planetary gear mechanism outputs rotating speed and torque through a connecting output roller of the gear ring of the planetary gear mechanism, the sun gear of the planetary gear mechanism inputs power by connecting to a power machine via a central roller, a hinge pin of the planetary gear is inserted into the corresponding hole on the sun gear;
the planetary carrier is floatingly arranged, and fixedly connected with the output disk with self-locking function which arranged on the small tooth number difference planetary gear;
an eccentric sleeve of the small tooth number difference planetary gear mechanism is connected with a small power motor for speed regulation via sleeve, the small power motor for speed regulation drives the eccentric sleeve of the small tooth number difference planetary gear mechanism to rotate by continuously input rotating speed, thereby the small tooth number difference planetary gear mechanism is unlocked with the the output disk with self-locking function thereof, and the floating planetary carrier of the planetary gear mechanism connected to the output disk is operated to perform a differential continuously variable transmission output;
the small tooth number difference planetary gear is provided with six hinge pins, the hinge pins are respectively inserted into eccentric holes of the eccentric sleeve on the output disk, thereby the small tooth number difference planetary gear mechanism is subjected to more than one peripheral force concentric with the eccentric sleeve of the small tooth number difference planetary gear mechanism, to achieve that the small tooth number difference planetary gear mechanism is constrained and self-locking;
the eccentric sleeve is mounted on the output disk by needle roller bearing, and the eccentric hole spacing of the eccentric sleeve is the same as the eccentric spacing of the small tooth number difference planetary gear mechanism, thereby the force that the six eccentric sleeves mounted on the output disk by needle roller bearing receives is two sets of eccentric forces against each other to achieve constrained self-locking.

2. The differential deceleration and continuously variable transmission gear box with self-locking functional small tooth number difference planetary gear of claim 1, wherein the small tooth number difference planetary differential gear mechanism and the output disk are connected with the output roller and arranged in engine base.

3. The differential deceleration and continuously variable transmission (CVT) gear box with self-locking functional small tooth number difference planetary gear of claim 1, wherein continuously variable transmission gear box is the main body of the invention, and the small tooth number difference planetary gear mechanism is the main body that realizes constrained self-locking.
